(19) United States
(12) Patent Application Publication
(10) Pub. No.: US 2024/0305716 A1
(43) Pub. Date: Sep. 12, 2024

(54) System and Method for Managing Communications in a Networked Call Center

(71) Applicant: Talkdesk, Inc., San Francisco, CA (US)

(72) Inventors: Ana Priscila Vieira Alves dos Santos, Lisbon (PT); Bin Ren, Wuhan (CN); Francisca Gomes Leal Santiago Pinto, Lisbon (PT); Jose Miguel Fernandes Do Seixo Soares Guilherme, Lisbon (PT); Xingchen Zhang, Wuhan (CN)

(21) Appl. No.: 18/117,905

(22) Filed: Mar. 6, 2023

(51) Int. Cl. H04M 3/523

(52) U.S. Cl. CPC H04M 3/5232; H04M 3/5238

(57) ABSTRACT

Disclosed implementations include a sequence of logic in a call center system to facilitate warm transfer operations, including when the warm transfer is to a party that is not part of, or integrated with, the call center. Disclosed implementations utilize a connection module to capture and parse connection information, such as a phone number, in a web page or other display on an agent's terminal. The connection information is replaced with a link that can be recognized by the call center and visually recognized by the agent. This provides the agent with a “click-to-call” function that can be used to achieve connection to a third-party expert or associated web page. The connection module ascertains the agent's status in the call center system, and connection logic is applied, based on the status, to execute an appropriate connection strategy in response to selection of the click-to-call operation by the agent.

### BACKGROUND

Cloud-based networked contact centers, also referred to as “call centers”, are well-known. In such call centers, service agents (referred to as “agents” herein) are assigned to queues based on skills and customer requirements. In a cloud-based contact center, all parties (including customers and agents) can be linked by the cloud-based contact center. FIG. 1 is an example system architecture of cloud-based call center environment. Customers 110 interact with contact center 150 to communicate with the agents 120, through a network 130, via at least one or more of text, email, voice or multimedia channels. Communication routing system 140 controls the routing and handling of communications between customers 110 and agents 120 for the contact center 150. Contact center 150 could be any of a contact center as a service (CCaaS) system, an automated call distributor (ACD) system, or a case system, for example.

Agents 120 may be remote from contact center 150 and handle communications (also referred to as “interactions” or “calls” herein) with customers 110 on behalf of an enterprise. Agents 120 may utilize devices, such as but not limited to, workstations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network (LAN). The network types are provided by way of example and are not intended to limit types of networks used for communications.

Agents 120 may be assigned to one or more queues representing call categories and/or agent skill levels. The agents 120 assigned to a queue may handle communications that are placed in the queue by the communication routing system 140. For example, there may be queues associated with a language (e.g., English or Chinese), topic (e.g., technical support or billing), or a particular country of origin. When a communication is received by the communication routing system 140, the communication may be placed in a relevant queue, and one of agents 120 associated with the relevant queue may assigned to the communication.

Agents may be assigned to one or more entities using the cloud-based contact center. Therefore, it is possible that agents, on any given day or shift, are providing support/service for customers of various entities. For example, an agent may handle a communication from a customer of a computer supplier and then immediately thereafter handle a communication from a customer of an automobile company. Accordingly, agents might not be trained in all aspects of customer service for each entity. The term “customer”, as used herein, refers to the party contacting the call center for support or other information and includes actual customers, potential customers, or any other party contacting the call center. Further, agents may be employees of the call center provider, employees of the entity using the call center service, contractors, or freelancers.

In some instances, an agent is not able to address the question/issue raised by a customer and must either transfer the customer to another party or consult with another party. It is known to use a “warm transfer”, which allows agents to make consultation calls with service personnel of other departments or parties without ending the conversation with the customer. This allows the agent to receive help from an expert while maintaining the ability maintaining the communication with the customer.

However, a consultation communication originated by warm transfer has a life cycle that can be entirely within a live conversation with the customer. As a result, the speed of initializing and completing the warm transfer will greatly affect the customer's experience. For example, when the warm transfer is accomplished to connect to a consultant that is not part of the call center system (an outside vendor or expert for example), the agent must identify and enter connection information (such as a phone number, telephony link, or web link) for the consultant, execute the connection information (e.g. enter a phone number or web address), and wait for connection to the consultant. This prevents the warm transfer from being affected quickly and smoothly and thus may lower quality of the customer experience.

### BRIEF SUMMARY

Disclosed implementations include a sequence of logic in a call center system to facilitate warm transfer operations, including when the warm transfer is to a party that is not part of, or integrated with, the call center. Disclosed implementations utilize a connection module, including a browser plug-in or other monitoring software, to capture and parse connection information, such as a phone number, in a web page or other display on an agent's terminal. The connection information is replaced with a link that can be recognized by the call center and visually recognized by the agent. This provides the agent with a “click-to-call” function that can be used to achieve connection to a third-party expert or associated web page (collectively referred to as “consultant” herein). The connection module ascertains the agent's status in the call center system, and connection logic is applied, based on the status, to execute an appropriate connection strategy in response to selection of the click-to-call operation by the agent. As an example, if the agent is in a live conversation, the call center will transfer the “click-to-call” action to “click-to-consult, and instead of starting a new conversation to the target number, the call center will initiate a consultation (warm transfer) to the number.

One disclosed implementation is a method for initiating communications within an automated call center, the method comprising: parsing, by a browser plug-in installed in a web browser of a call center agent, text of a web page of a third-party consultant to obtain parsed text; applying at least one of an expression format to the parsed text to identity at least one set of connection data in the parsed text; identifying segments of the at least one phone number; inserting the segments into a data structure in accordance with a URL schema compatible with a communication routing module of the automated call center; converting the data structure into a link that is displayed on a user interface of an agent computing device; in response to selection of the link by the agent through the user interface, transmitting a communication request to the routing module; querying a call status of the agent; calling, by the routing module, an application of the automated call center that is specified by the routing request; and initiating a communication with the third-party consultant in accordance with at least one rule which includes the status of the agent as a rule parameter.

### BRIEF DESCRIPTION OF THE DRAWING

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 is a block diagram of a computer architecture of a conventional call center environment.

FIG. 2 is a flow chart of a method for initiating a communication in accordance with disclosed implementations.

FIG. 3 is a flow chart of call initiation logic in accordance with disclosed implementations.

FIG. 4 is a block diagram of a computer contact center connection module in accordance with disclosed implementations.

FIG. 5a illustrates a user interface in accordance with disclosed implementations.

FIG. 5b illustrates a user interface in accordance with disclosed implementations.

FIG. 6a shows a phone number user interface in accordance with disclosed implementations.

FIG. 6b shows a phone number user interface with generated links in accordance with disclosed implementations.

FIG. 6c shows a phone number user interface in accordance with disclosed implementations.

FIG. 7 shows a consultation transfer user interface in accordance with disclosed implementations.

### DETAILED DESCRIPTION

Certain terminology is used in the following description for convenience only and is not limiting. Unless specifically set forth herein, the terms “a,” “an” and “the” are not limited to one element but instead should be read as meaning “at least one.” The terminology includes the words noted above, derivatives thereof and words of similar import.

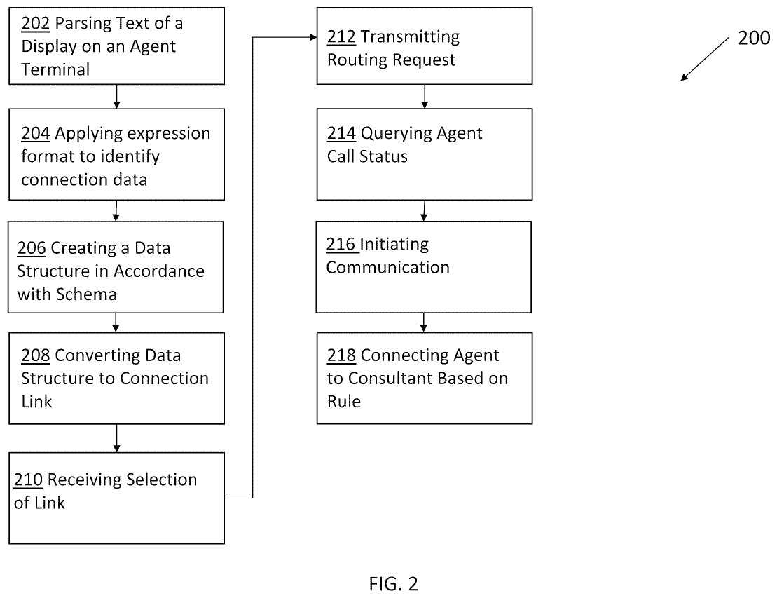

FIG. 2 illustrates process 200 for initiating consulting communications in accordance with disclosed implementations. As shown in FIG. 2, process 200 begins at 202 by parsing text of a display on an agent terminal. In one example the display can be retrieved as a result of a web search or other query for a consulting party. A plug-in, such as a browser plug-in, can capture visible text being displayed on the display device of the agent terminal. This can be accomplished using a JavaScript Document Object Model (DOM) Application Programming Interface (API) for example. The parsing step can also include converting any image data on the display into text through Optical Character Recognition (OCR).

At step 204, connection information on the display, such as a phone number, is identified by matching the text and one or more regular expression formats that are applied. For example, the expression format [###-###-####] can be applied to identify phone numbers. Further additional rules can be applied to identify the connection information. For example, if an identified phone number is near the word “office” this can be identified as valid connection information as opposed to a fax number or other number that may fit the format of a phone number. The plug-in can identify the segments and components (the country code, area code, body, etc.) of the number and extension from phone numbers by applying the standard E.164 format for example.

At step 206, a connection data structure is created in accordance with a predefined schema that is recognized by the call center. For example, the plug-in can automatically insert an identified phone number into tel-link protocol URL schemas that are recognized by the call center (e.g., [CC prefix]+tel://(800)373-3411). Tel-link protocols are used for setting up click-to-call options online. By using a tel-link protocol, a phone number call link is created on a website, usually in a form of a text link, button or image. Accordingly, the link associated with the connection information can be displayed on the display device of the agent's terminal as a text link, button, image, or other UI element.

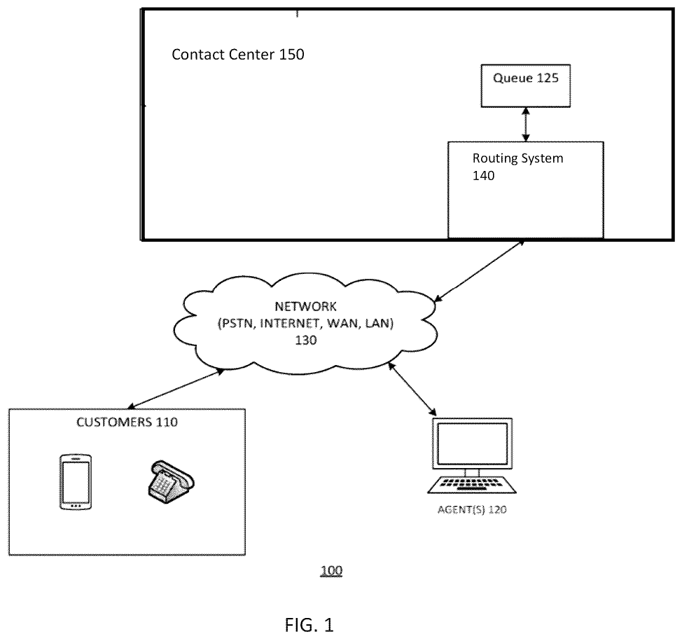

At step 210, the agent actuates the UI element, e.g., the agent could click the phone number link to initiate a new call to the consultant. The plug-on can intercept the browser's default click-to-call request and forward it to a call center application to ensure that the communication is established through a desired application of the call center. In response to the actuation of the UI element, a communication request is transmitted to a routing system (such as routing systems 140 of FIG. 1) at step 212. It is possible to configure which call center application is requested through the plug-in. Therefore, if the call center application has different applications for initiating calls (e.g, a desktop application, a web application, different versions etc.), the appropriate application is used to initiate a call.

In response to the click-to-call request reaches, the call center application receives the URL schema and identifies each segment within the URL schema. At step 214, the status of the agent initiating the communication is determined, through a query of an agent parameter in a databased for example, and the agent is connected to the desired consulting party in accordance with a rule applied based on the agent status, at step 218.

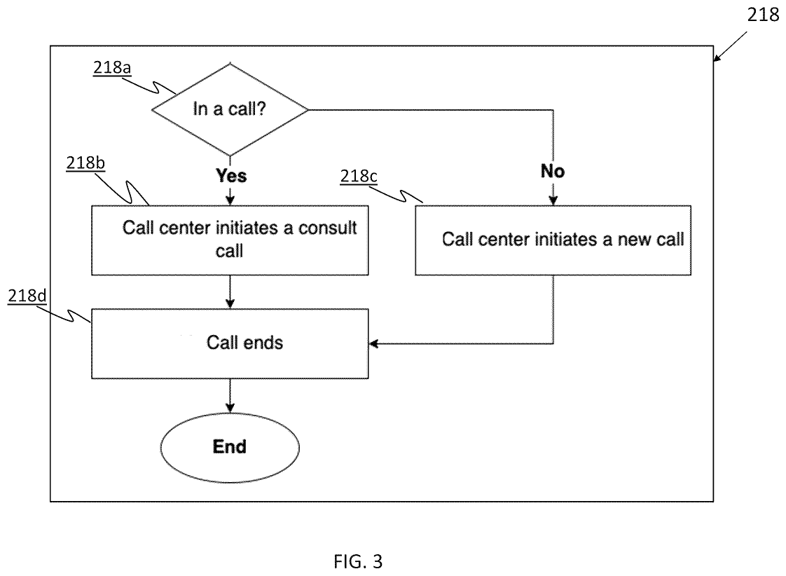

FIG. 3 illustrates and example of logic that can be applied in step 218. For example, if, at step 218a, it is determined that the agent is already in a live conversation (synchronous communication) with a customer, instead of initiating a new distinct call the call center application could start a warm transfer to the number which has been requested by the click-to-call operation, as step 218b. At this time, the call center will build a consultation call connection to the target number, and once the connection is created, the original conversation with the customer will be put on hold. This ensures a quick consultation that can be built instead of locating a number and back to the call center application to go through the consultation process via its UI. On the other hand, if the agent is determined to be in an idle status (or otherwise not on a synchronous call), the call center can, at step 218c, follow a normal click-to-call logic to start a standard outbound call to the target number. This guarantees that the click-to-call function could also work in cases where the customer is not still in synchronous communication with the agent. At 218d, the agent can terminate the call in a conventional manner.

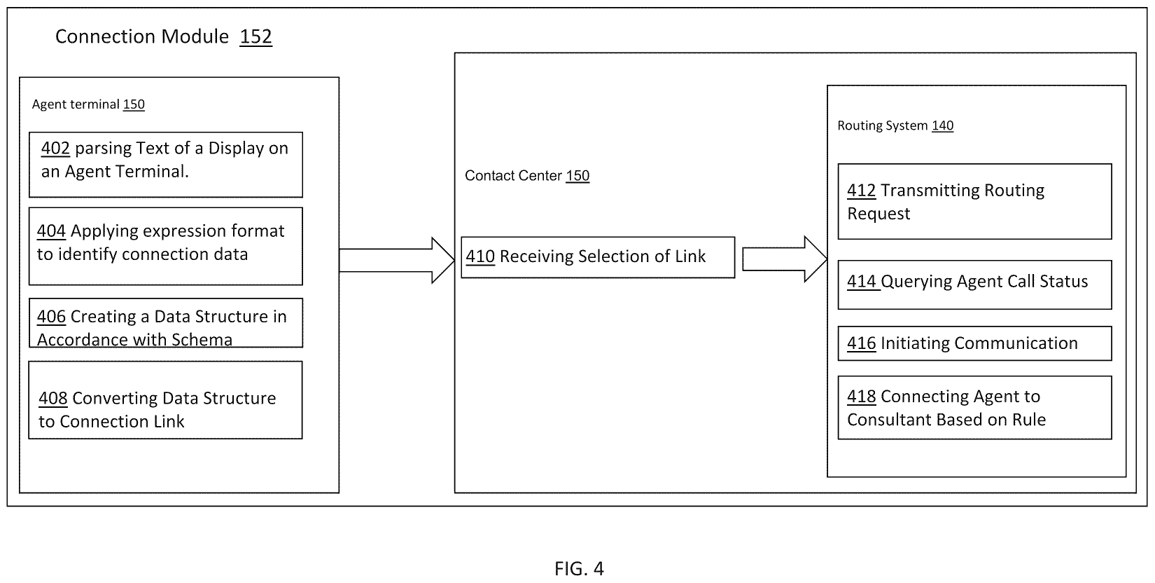

FIG. 4 illustrates a connection module 152 that can be implemented, for example, in contact center 150 of FIG. 1, in accordance with disclosed embodiments. Connection module 152 includes non-transient memory and at least one computer processor 460. Various other “modules” that make up connection module 152 are defined by code stored in the memory and can be executed by processor(s). The interaction of these modules will become apparent based on the description below.

Code modules 402, 404, 406, and 408 can be executed, as a plug-in for example, in agent terminal 150. Code 402 parses text of a display on an agent terminal. In one example the display can be retrieved as a result of a web search or other query for a consulting party. A plug-in, such as a browser plug-in, can capture visible text being displayed on the display device of the agent terminal. This can be accomplished using a JavaScript Document Object Model (DOM) Application Programming Interface (API) for example. The parsing step can also include converting any image data on the display into text through Optical Character Recognition (OCR).

Code 404, identifies connection information on the display, such as a phone number, by matching the text and one or more regular expression formats that are applied. For example, the expression format [###-###-####] can be applied to identify phone numbers. Further additional rules can be applied to identify the connection information. For example, if an identified phone number is near the word “office” this can be identified as valid connection information as opposed to a fax number or other number that may fit the format of a phone number. The plug-in can identify the segments and components from phone numbers, following the standard E.164 format, for example, the country code, area code, body of the number and extension.

Code 406, creates a connection data structure in accordance with a predefined schema that is recognized by the call center. Code 408 can, for example, automatically insert the identified phone number into tel-link protocol URL schemas that are recognized by the call center (e.g., [CC prefix]+tel://(800)373-3411). To create a link. Tel-link protocols are used for setting up calling click-to-call options online. By using a tel-link protocol a phone number call link is created on a website, usually in a form of a text link, button or image. Accordingly, the link associated with the connection information can be displayed on the display device of the agent terminal as a text link, button, image, or other UI element.

Code modules 410, 412, 414, 416, and 418 can be executed in contact center 150 (with code 412, 414, 416 and 418 being executed as part of routing system 140). Code 410 receives an actuation of the UI element from the agent, e.g., the agent could click the phone number links to initiate either a new call to the consultant. The plug-in can intercept the browser's default click-to-call request and forward it to a call center application to ensure that the communication is established through a desired application of the call center. In response to the actuation of the UI element, a communication request is transmitted to a routing system (such as routing systems 140 of FIG. 1) by code 412. It is possible to configure which call center application is requested through the plug-in. Therefore, if the call center application has different applications for initiating calls (e.g, a desktop application, a web application, different versions etc.), the appropriate application is used to initiate a call.

The call center application receives the URL schema and identifies each segment within the URL schema. Code 414 determines the status of the agent initiating the communication, through a query of an agent parameter in a databased for example, and the agent is connected to the desired consulting party in accordance with a rule applied based on the agent status by code 418.

The computing devices implementing disclosed implementations can include a variety of tangible computer readable media. Computer readable media can be any available tangible media that can be accessed by device and includes both volatile and non-volatile media, removable and non-removable media. Tangible, non-transient computer storage media include volatile and non-volatile, and removable and non-removable media implemented in any method or technology for storage of information such as computer readable instructions, data structures, program modules or other data.

The various data and code can be stored in electronic storage devices which may comprise non-transitory storage media that electronically stores information. The electronic storage media of the electronic storage may include one or both of system storage that is provided integrally (i.e., substantially non-removable) with the computing devices and/or removable storage that is removably connectable to the computing devices via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media.

Processor(s) of the computing devices may be configured to provide information processing capabilities and may include one or more of a digital processor, an analog processor, a digital circuit designed to process information, an analog circuit designed to process information, a state machine, and/or other mechanisms for electronically processing information. As used herein, the term “module” may refer to any component or set of components that perform the functionality attributed to the module. This may include one or more physical processors during execution of processor readable instructions, the processor readable instructions, circuitry, hardware, storage media, or any other components.

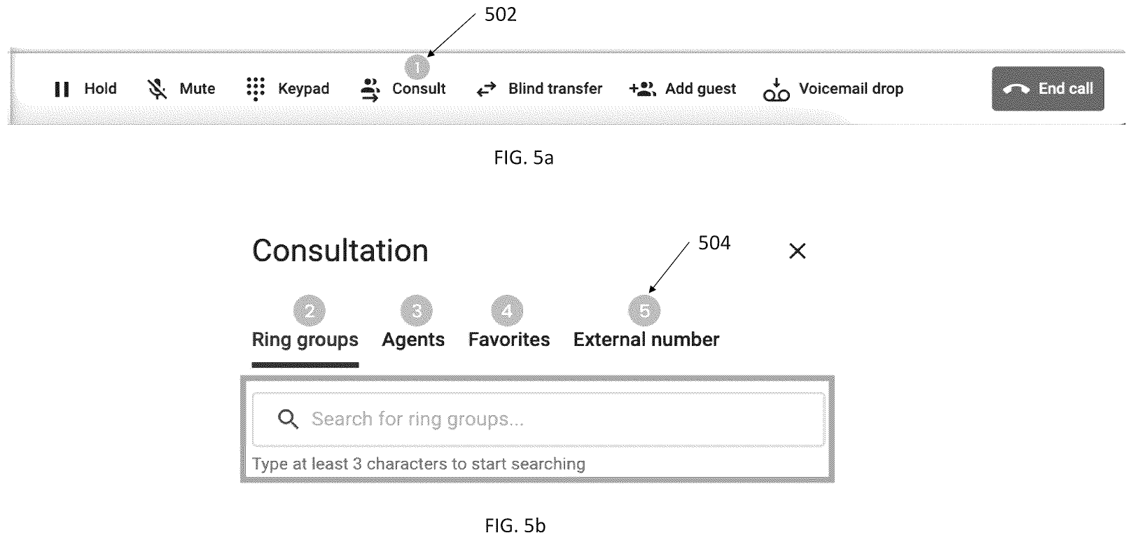

Disclosed implementations can be invoked by an agent by selecting a consult UI element, such as UI element 502 if the user interface shown in FIG. 5a. The agent can then select, for example, external number UI element 504 of the user interface shown in FIG. 5b. Selecting UI element 504 can cause the method of FIG. 2 to be accomplished. Following the consultation, the agent can decide to:
Go back to the original call permanently, by ending the consultation;
Transfer the original call to the consulting party; or
Add the contact person to the consultation communication.

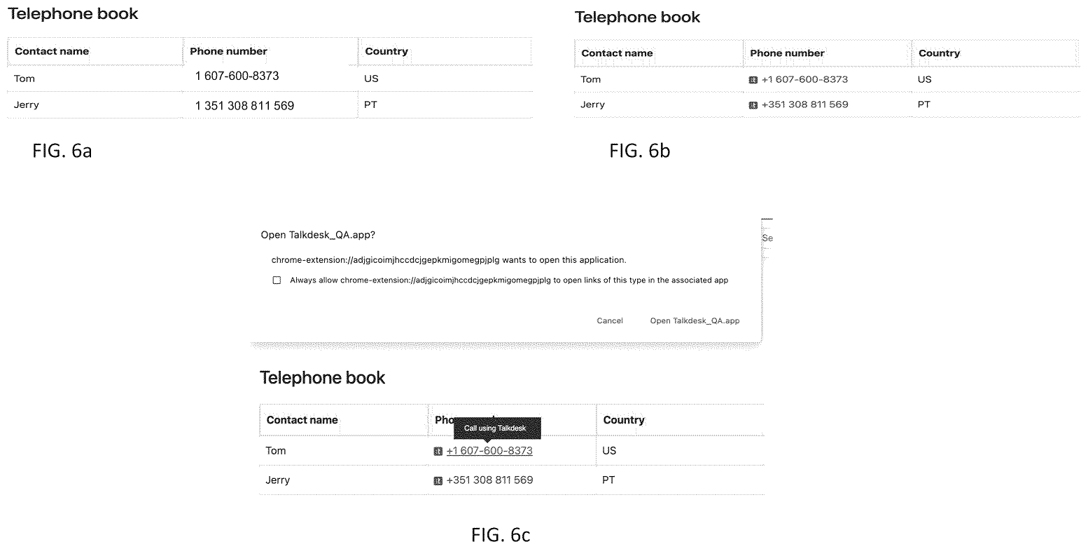

FIGS. 6a, 6b, and 6c illustrate a user interface of the plugin code on an agent's browser. FIG. 6a shows the original status a portion of the browser window on the agent's display screen. Text can be, for example, either in pure text format or in the default telephone link format (which will not link to the call center that the agent is currently using). FIG. 6b shows the same portion of the browser window after running the plugin. As noted above, the plugin can parse phone numbers, create links and transfer the links in a manner/format recognized by the call center. FIG. 6c shows the browser display after clicking on any one of the links generated for the phone numbers, wherein the browser will switch to the call center application and provide appropriate actions, such as call connections, in the call center.

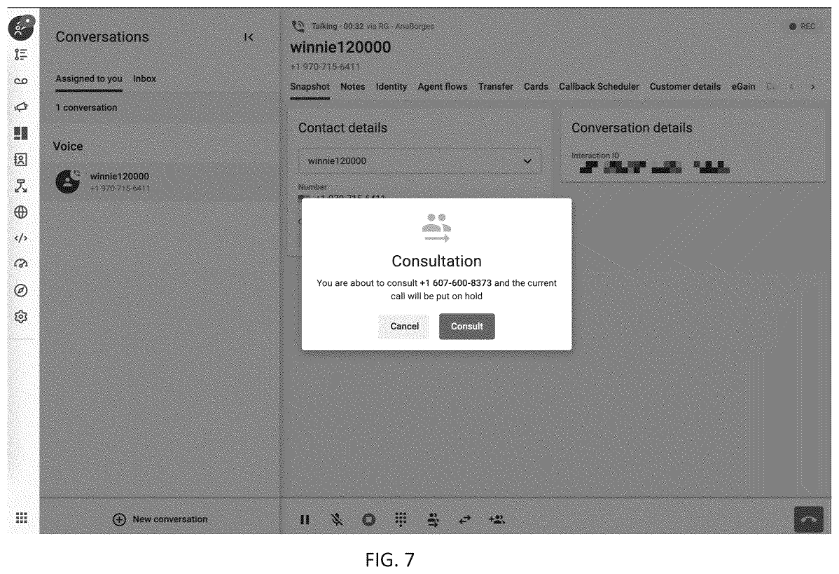

FIG. 7 shows a screenshot of how the Call Center will start a consultation call if the agent is in a busy status, after clicking the link transferred by the plugin. The shadowed part is a normal screen during the call, and instead of letting the agent click the buttons and go through the steps in FIG. 5, the call center application directly shows the pop-up, so that the agent can start the consultation immediately with a user interface selection.

The contact center 150 of FIG. 1 can be in a single location or may be cloud-based and distributed over a plurality of locations, i.e., a distributed computing system. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The disclosed implementations apply logic, based on an identification of the agent's status to increase the flexibility and speed when a consulting call is required. The time required for an agent to make a consultation call to a number which is not saved in the call center application is reduced and thus the experience of the customer who is on the call with the agent is improved.

It will be appreciated by those skilled in the art that changes could be made to the disclosed implementations without departing from the broad inventive concept thereof. It is understood, therefore, that this invention is not limited to the disclosed implementations, but it is intended to cover modifications within the spirit and scope of the present invention as defined by the appended claims.

What is claimed:

1. A method of initiating communications within an automated call center, the method comprising:
parsing, by a browser plug-in installed in a web browser of a call center agent, text of a web page of a third-party consultant to obtain parsed text;
applying at least one of an expression format to the parsed text to identity at least one set of connection data in the parsed text;
identifying segments of the at least one set of connection data;
inserting the segments into a data structure in accordance with a URL schema compatible with a communication routing module of the automated call center;
converting the data structure into a link that is displayed on a user interface of an agent computing device;
in response to selection of the link by the agent through the user interface, transmitting a communication request to the routing module;
querying a call status of the agent;
calling, by the routing module, an application of the automated call center that is specified by the routing request; and
initiating a communication with the third-party consultant in accordance with at least one rule which includes the status of the agent as a rule parameter.

2. The method of claim 1, wherein the initiating comprises:
establishing an outbound communication between the agent and the third-party consultant when status of the agent is idle; and
establishing and outbound communication between the agent and the third-party consultant and placing a current communication being handled by the agent on hold when the status of the agent is active.

3. The method of claim 1, where the connection data includes a phone number.

4. A contact center system for initiating communications within an automated call center, the method comprising:
an agent computing device having a browser plugin executing thereon, the browser plugin, when executed by a processor of the agent device, being operative to:
parse, text of a web page of a third-party consultant displayed in the agent computing device to obtain parsed text;
apply at least one of an expression format to the parsed text to identity at least one set of connection data in the parsed text;
identify segments of the at least one set of connection data;
insert the segments into a data structure in accordance with a URL schema compatible with a communication routing module of an automated call center;
convert the data structure into a link that is displayed on a user interface of an agent computing device; and
in response to selection of the link by the agent through the user interface, transmitting a communication request to the routing module;
a call center server having a routing module executing thereon which, when executed by a processor of the call center server, being operative to:
in response to receiving the communication request, querying a call status of the agent;
calling, by the routing module, an application of the automated call center that is specified by the routing request; and
initiating a communication with the third-party consultant in accordance with at least one rule which includes the status of the agent as a rule parameter.

5. The method of claim 4, wherein the initiating comprises:
establishing an outbound communication between the agent and the third-party consultant when status of the agent is idle; and
establishing and outbound communication between the agent and the third-party consultant and placing a current communication being handled by the agent on hold when the status of the agent is active.

6. The system of claim 4, where the connection data includes a phone number.
